(19) United States
(12) Patent Application Publication
(10) Pub. No.: US 2026/0292168 A1
(43) Pub. Date: Sep. 24, 2026

(54) EXTRAPOLATION FILTER-BASED INTRA PREDICTION

(71) Applicant: TENCENT TECHNOLOGY (SHENZHEN) COMPANY LIMITED, Shenzhen (CN)

(72) Inventor: Xiaozhong XU, Shenzhen (CN)

(73) Assignee: TENCENT TECHNOLOGY (SHENZHEN) COMPANY LIMITED, Shenzhen (CN)

(21) Appl. No.: 19/688,411

(22) Filed: May 26, 2026

Related U.S. Application Data
(63) Continuation of application No. PCT/CN2025/113399, filed on Aug. 8, 2025.

(30) Foreign Application Priority Data
Aug. 9, 2024 (CN) 202411099982.4

(51) Int. Cl. H04N 19/117; H04N 19/119; H04N 19/13; H04N 19/159; H04N 19/176; H04N 19/593

(52) U.S. Cl. CPC H04N 19/117; H04N 19/119; H04N 19/13; H04N 19/159; H04N 19/176; H04N 19/593

(57) ABSTRACT

A method for video decoding is provided. In the method, a video bitstream including coding information of a current block is received. A filter coefficient of a filter for the current block is determined based on an extrapolation filter-based intra prediction (EIP) mode. The filter coefficient is determined based on a correlation between pixel values of a reference region in a plurality of input positions of the filter and a pixel value of the reference region in an output position of the filter. A compensation value for the filter coefficient is decoded from the video bitstream. An adjusted filter coefficient of the filter is generated based on the compensation value and the filter coefficient. The current block is reconstructed based on the adjusted filter coefficient of the filter.

### RELATED APPLICATIONS

The present application is a continuation of International Application No. PCT/CN2025/113399, filed on Aug. 8, 2025, which claims priority to Chinese Patent Application No. 202411099982.4, filed on Aug. 9, 2024. The entire disclosures of the prior applications are hereby incorporated by reference.

### FIELD OF THE TECHNOLOGY

This disclosure relates to the field of video coding and decoding, including an improvement to extrapolation filter-based intra prediction.

### BACKGROUND

In the field of video coding and decoding, an intra prediction mode is to derive a predicted value of a current block from an adjacent region based on a correlation that exists in pixels of a video image in a space domain. In an extrapolation filter-based intra prediction (EIP) mode, a coefficient of an extrapolation filter is obtained by using a preset filter template from a reference region adjacent to a current block, and then predicted pixels are generated in a specific order in the current block.

For a current block using an EIP mode, a filter coefficient is derived by using pixels in a reference region adjacent to the current block. In this case, a prediction effect decreases as the pixels in the current block are far from the reference region. Consequently, the accuracy of intra prediction is affected, and the coding and decoding efficiency is reduced.

### SUMMARY

Aspects of the disclosure provide a video coding method and apparatus, a video decoding method and apparatus, a computer-readable medium, and an electronic device, which may optimize a filter coefficient of a reference region corresponding to a current block, thereby improving the accuracy of intra prediction, and helping improve the video coding and decoding efficiency.

Other characteristics and advantages of the disclosure will become clearer through the following detailed description or be partially learned through practice of the disclosure.

According to an aspect of the disclosure, a method for video decoding is provided. In the method, a video bitstream including coding information of a current block is received. A filter coefficient of a filter for the current block is determined based on an extrapolation filter-based intra prediction (EIP) mode. The filter coefficient is determined based on a correlation between pixel values of a reference region in a plurality of input positions of the filter and a pixel value of the reference region in an output position of the filter. A compensation value for the filter coefficient is decoded from the video bitstream. An adjusted filter coefficient of the filter is generated based on the compensation value and the filter coefficient. The current block is reconstructed based on the adjusted filter coefficient of the filter.

According to another aspect of the disclosure, a method for video encoding is provided. In the method, an actual filter coefficient for a current block in a filter is determined based on reference samples of the current block. A derived filter coefficient of the filter for the current block is determined based on an extrapolation filter-based intra prediction (EIP) mode. The derived filter coefficient is determined based on a correlation between pixel values of a reference region in a plurality of input positions of the filter and a pixel value of the reference region in an output position of the filter. A compensation value is determined based on a difference between the actual filter coefficient and the derived filter coefficient. Intra prediction is performed on the current block by using at least one of the actual filter coefficient or the derived filter coefficient of the filter based on the EIP mode. The compensation value is encoded into a video bitstream.

According to yet another aspect of the disclosure, a non-transitory computer-readable storage medium is provided. The non-transitory computer-readable storage medium stores instructions which, when executed by a processor, cause the processor to perform a method of encoding a video bitstream. In the method, an actual filter coefficient for a current block in a filter is determined based on reference samples of the current block. A derived filter coefficient of the filter for the current block is determined based on an extrapolation filter-based intra prediction (EIP) mode. The derived filter coefficient is determined based on a correlation between pixel values of a reference region in a plurality of input positions of the filter and a pixel value of the reference region in an output position of the filter. A compensation value is determined based on a difference between the actual filter coefficient and the derived filter coefficient. Intra prediction is performed on the current block by using at least one of the actual filter coefficient or the derived filter coefficient of the filter based on the EIP mode. The compensation value is encoded into the video bitstream and the encoded video bitstream is transmitted.

According to a first aspect, an embodiment of the disclosure provides a video decoding method, including: acquiring a coded video bitstream; acquiring a filter coefficient of a current block, the filter coefficient being configured for an extrapolation filter-based intra prediction mode; decoding a compensation value for the filter coefficient from the video bitstream; generating an adjusted filter coefficient based on the compensation value and the filter coefficient; and performing prediction on the current block by using the adjusted filter coefficient.

According to a second aspect, an embodiment of the disclosure provides a video coding method, including: acquiring a filter coefficient of a current block and a compensation value for the filter coefficient, the filter coefficient being configured for an extrapolation filter-based intra prediction mode; generating an adjusted filter coefficient based on the compensation value and the filter coefficient; performing intra prediction on the current block by using the adjusted filter coefficient; and encoding the compensation value into a video bitstream.

According to a third aspect, an embodiment of the disclosure provides a video decoding apparatus, including: an acquisition unit, configured to acquire a coded video bitstream, and acquire a filter coefficient of a current block, the filter coefficient being configured for an extrapolation filter-based intra prediction mode; a decoding unit, configured to decode a compensation value for the filter coefficient of the current block from the video bitstream; a generation unit, configured to generate an adjusted filter coefficient based on the compensation value and the filter coefficient; and a processing unit, configured to perform prediction on the current block by using the adjusted filter coefficient.

According to a fourth aspect, an embodiment of the disclosure provides a video coding apparatus, including: an acquisition unit, configured to acquire a filter coefficient of a current block and a compensation value for the filter coefficient, the filter coefficient being configured for an extrapolation filter-based intra prediction mode; a generation unit, configured to generate an adjusted filter coefficient based on the compensation value and the filter coefficient; and a processing unit, configured to perform intra prediction on the current block by using the adjusted filter coefficient, and code the compensation value into a video bitstream. According to a fifth aspect, an embodiment of the disclosure provides a computer-readable medium, having a computer program stored therein, when the computer program being executed by a processor, the video decoding method or the video coding method according to the foregoing aspects being implemented.

According to a sixth aspect, an embodiment of the disclosure provides an electronic device, including one or more processors and a storage apparatus, the storage apparatus being configured to store one or more computer programs, the one or more computer programs, when executed by the one or more processors, causing the electronic device to implement the video decoding method or the video coding method according to the foregoing aspects.

According to a seventh aspect, an embodiment of the disclosure provides a computer program product, the computer program product including a computer program, the computer program being stored in a computer-readable storage medium. A processor of an electronic device reads the computer program from the computer-readable storage medium and executes the computer program to cause the electronic device to perform the video decoding method or the video coding method according to the foregoing aspects.

### BRIEF DESCRIPTION OF THE DRAWINGS

FIG. 1 shows a schematic diagram of an example of a system architecture that may apply technical solutions in aspects of the disclosure.

FIG. 2 shows a schematic diagram of an arrangement mode of a video coding apparatus and a video decoding apparatus in a streaming system.

FIG. 3 shows a basic flowchart of a video coder.

FIG. 4 shows a schematic diagram of an angle prediction direction in an intra prediction mode.

FIG. 5 shows a schematic diagram of intra prediction.

FIG. 6 shows a schematic diagram of distribution of intra prediction residuals according to an embodiment of the disclosure.

FIG. 7 shows a schematic diagram of a shape of a filter template that may be used in EIP according to an embodiment of the disclosure.

FIG. 8 shows a schematic diagram of a shape of a reference region that may be used in EIP according to an embodiment of the disclosure.

FIG. 9 shows a schematic diagram of generation of predicted pixels in a diagonal scanning order according to an embodiment of the disclosure.

FIG. 10 shows a flowchart of a video decoding method according to an embodiment of the disclosure.

FIG. 11 shows a schematic diagram of region partitioning in a current block according to an embodiment of the disclosure.

FIG. 12 shows a schematic diagram of region partitioning in a current block according to an embodiment of the disclosure.

FIG. 13 shows a schematic diagram of region partitioning in a current block according to an embodiment of the disclosure.

FIG. 14 shows a flowchart of a video decoding method according to an embodiment of the disclosure.

FIG. 15 shows a flowchart of a video coding method according to an embodiment of the disclosure.

FIG. 16 shows a block diagram of a video decoding apparatus according to an embodiment of the disclosure.

FIG. 17 shows a block diagram of a video coding apparatus according to an embodiment of the disclosure.

FIG. 18 shows a schematic structural diagram of a computer system adapted to implement an electronic device according to an embodiment of the disclosure.

### DETAILED DESCRIPTION

Implementations are described in further detail with reference to the accompanying drawings. However, the implementations can be implemented in various forms, and are not to be understood as being limited to the examples. On the contrary, these implementations are provided so as to convey the concept of the implementations to those skilled in the art.

In addition, the features, structures, or characteristics described in the disclosure may be combined in one or more aspects in any proper mode. In the following descriptions, many specific details are provided for understanding of the aspects of the disclosure. However, those skilled in the art are to be aware that the technical solutions in the disclosure may be implemented without using all details in the aspects, namely, one or more details may be omitted, or may be implemented by using other methods, elements, apparatuses, steps, or the like.

Descriptions of terms in this disclosure are provided as examples only and are not intended to limit the scope of the disclosure.

In the aspects of the disclosure, the term “module” or “unit” refers to a computer program with a preset function or a part of the computer program, that works together with other related parts to implement a preset target, and may be substantially or partially implemented by using software, hardware (e.g., a processing circuit or a memory), or a combination thereof. Similarly, one processor (or a plurality of processor or memories) may be configured to implement one or more modules or units. In addition, each module or unit may be a part of an entire module or unit that includes the module or unit function.

The block diagrams shown in the accompanying drawings are merely functional entities and do not necessarily correspond to physically independent entities, i.e., the functional entities may be implemented in a software form, or the functional entities may be implemented in one or more hardware modules or integrated circuits, or the functional entities may be implemented in different networks, and/or processor apparatuses, and/or microcontroller apparatuses.

The flowcharts shown in the accompanying drawings are merely examples of descriptions, and do not necessarily include all contents and operations/steps, nor be executed in the described order. For example, some operations/steps may further be broken down, while some operations/steps may be combined or partially combined. Therefore, an actual execution order may change according to an actual situation.

“A plurality of” mentioned herein means two or more. The term “and/or” describes an association relationship between associated objects, and indicates that three relationships may exist. For example, A and/or B may indicate the following three cases: only A exists, both A and B exist, and only B exists. The character “/” indicates an “or” relationship between associated objects.

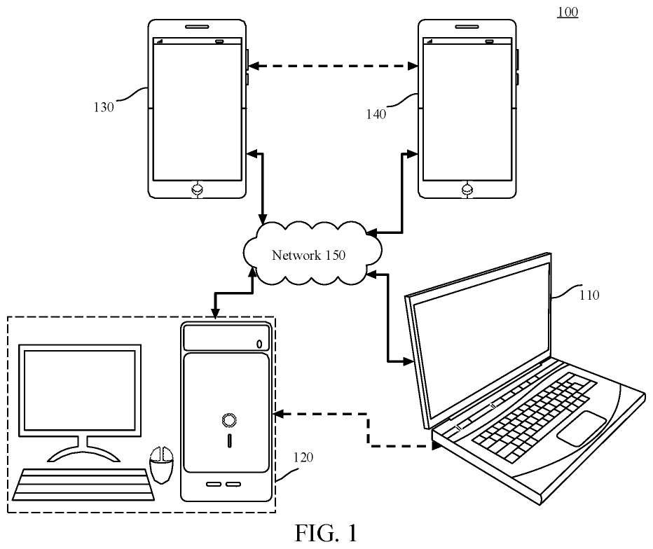

FIG. 1 shows a schematic diagram of an example of a system architecture which may apply technical solutions in aspects of the disclosure.

As shown in FIG. 1, a system architecture 100 includes a plurality of terminal apparatuses, and the terminal apparatuses may communicate with each other through, for example, a network 150. For example, the system architecture 100 may include a first terminal apparatus 110 and a second terminal apparatus 120 that are interconnected through the network 150. In the embodiment of FIG. 1, the first terminal apparatus 110 and the second terminal apparatus 120 perform unidirectional data transmission.

For example, the first terminal apparatus 110 may code video data (e.g., a video picture stream collected by the terminal apparatus 110) for transmission to the second terminal apparatus 120 through the network 150. The coded video data is transmitted in a form of one or more coded video bitstreams. The second terminal apparatus 120 may receive the coded video data from the network 150, decode the coded video data to recover the video data, and display video pictures based on the recovered video data.

In an embodiment of the disclosure, the system architecture 100 may include a third terminal apparatus 130 and a fourth terminal apparatus 140 that perform bidirectional transmission of coded video data. The bidirectional transmission may occur, for example, during a video conference. For bidirectional data transmission, each of the third terminal apparatus 130 and the fourth terminal apparatus 140 may code video data (e.g., video picture streams collected by the terminal apparatuses) for transmission to the other of the third terminal apparatus 130 and the fourth terminal apparatus 140 through the network 150. Each of the third terminal apparatus 130 and the fourth terminal apparatus 140 may also receive the coded video data transmitted by the other of the third terminal apparatus 130 and the fourth terminal apparatus 140, decode the coded video data to recover the video data, and display video pictures on accessible display apparatuses based on the recovered video data.

In the embodiment shown in FIG. 1, the first terminal apparatus 110, the second terminal apparatus 120, the third terminal apparatus 130, and the fourth terminal apparatus 140 may be servers or terminals, but the principle disclosed in the disclosure may not be limited thereto.

The servers may be independent physical servers, or a server cluster or a distributed system including a plurality of physical servers, or may also be cloud servers that provide cloud services, cloud databases, cloud computing, cloud functions, cloud storage, network services, cloud communication, middleware services, domain name services, security services, content delivery networks (CDNs), and basic cloud computing services such as big data and artificial intelligence platforms. The terminals may be smart phones, tablet computers, notebook computers, desktop computers, smart speakers, smart voice interaction devices, smart watches, smart household appliances, on-board terminals, air vehicles, or the like, which is not limited thereto.

The network 150 shown in FIG. 1 represents any number of networks for transmitting the coded video data between the first terminal apparatus 110, the second terminal apparatus 120, the third terminal apparatus 130, and the fourth terminal apparatus 140, and includes, for example, a wired and/or wireless communication network. The communication network 150 may exchange data in a circuit-switched and/or packet-switched channel. The network may include a telecommunication network, a local area network, a wide area network, and/or the Internet. For the objectives of the disclosure, unless explained below, the architecture and topology of the network 150 may be inconsequential to operations disclosed in the disclosure.

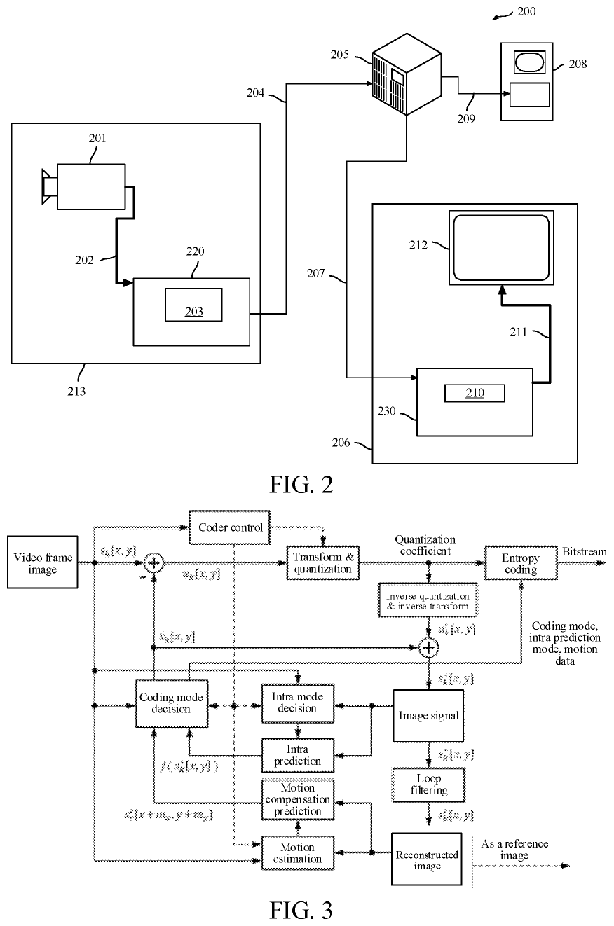

In an embodiment of the disclosure, FIG. 2 shows an arrangement mode of a video coding apparatus and a video decoding apparatus in a streaming environment. The subject disclosed in the disclosure may be equally applicable to other applications supporting videos, including, for example, video conference, digital televisions (TVs), and storage of compressed videos on digital mediums including compact discs (CDs), digital video discs (DVDs) and memory sticks.

A streaming system 200 may include a collection subsystem 213. The collection subsystem 213 may include a video source 201 such as a digital camera. The video source creates an uncompressed video picture stream 202. In an embodiment, the video picture stream 202 includes a sample captured by a digital camera. Compared with coded video data 204 (or a coded video bitstream 204), the video picture stream 202 is drawn with a bold line to emphasize a video picture stream with a high data volume. The video picture stream 202 may be processed by an electronic apparatus 220. The electronic apparatus 220 includes a video coding apparatus 203 coupled to the video source 201. The video coding apparatus 203 may include hardware, software, or a combination of software and hardware to achieve or implement aspects of the disclosed subject described in more detail below. Compared with the video picture stream 202, the coded video data 204 (or the coded video bitstream 204) is drawn with a thin line to emphasize the coded video data 204 (or the coded video bitstream 204) with a relatively low data volume, and may be stored on a streaming server 205 for future use. One or more streaming client subsystems, for example, a client subsystem 206 and a client subsystem 208 in FIG. 2, may access the streaming server 205 to retrieve a copy 207 and a copy 209 of the coded video data 204. The client subsystem 206 may include, for example, a video decoding apparatus 210 in an electronic apparatus 230. The video decoding apparatus 210 decodes the incoming copy 207 of the coded video data, and generates an output video picture stream 211 that may be presented on a display 212 (e.g., a display screen) or another presentation apparatus. In some streaming systems, the coded video data 204, video data 207, and video data 209 (e.g., video bitstreams) may be coded according to some video coding/compression standards.

The electronic device 220 and the electronic device 230 may include other components not shown in the figures. For example, the electronic device 220 may include a video decoding apparatus, and the electronic device 230 may include a video coding apparatus.

In an embodiment of the disclosure, taking the high efficiency video coding (HEVC) and versatile video coding (VVC) in international video coding standards, as well as the Chinese national video coding standard AVS as examples, after a video frame image is inputted, the video frame image is partitioned into several non-overlapping processing units based on a block size, and each processing unit performs similar compression operations. The processing unit is called a coding tree unit (CTU) or a largest coding unit (LCU). The CTU may be further partitioned more finely to obtain one or more basic coding units (CU). The CU is the most basic element in a coding process.

In another embodiment, the processing unit may also be called a tile, and is a rectangular region of a multimedia data frame that may be independently decoded and coded. In the alliance for open media video 1 (AV1) standard, a tile may be further partitioned more finely to obtain one or more superblocks (SBs). The SB is a starting point of block partitioning and may be further partitioned into a plurality of subblocks. Then the SB is further partitioned to obtain one or more blocks. Each block is the most basic element in a coding process. In some aspects, one SB may include several Bs.

The foregoing partitioning mode for the video frame image may be called a block partition structure. The following describes some concepts in a coding process.

According to an aspect of the disclosure, predictive coding includes intra prediction and inter prediction, and a residual video signal is obtained after an original video signal is predicted by a selected reconstructed video signal. A coder side needs to determine which predictive coding mode to select for a current coding unit (or coding block), and inform a decoder side. Intra prediction refers to that a predicted signal is from a region that has been coded and reconstructed in the same image. Inter prediction refers to that a predicted signal is from other images that have been coded (called reference images) different from a current image.

According to an aspect of the disclosure, transform & quantization are applied. In the transform, after a residual video signal undergoes transform operations such as discrete Fourier transform (DFT) and discrete cosine transform (DCT), the signal is converted into a transform domain, which is called a transform coefficient. In the quantization, lossy quantization is further performed on the transform coefficient, to lose certain information, so that the quantized signal is beneficial to compression and expression. In some video coding standards, more than one transform mode may be selected. Therefore, a coder side also needs to select one transform mode for a current coding unit (or coding block), and inform a decoder side of the transform mode. The quantization fineness is typically determined by a quantization parameter (QP). A large QP value indicates that coefficients in a large value range are quantized to the same output, which typically causes large distortion and a low bit rate. On the contrary, a small QP value indicates that coefficients in a small value range are quantized into the same output, which typically causes small distortion and a corresponding high bit rate.

According to an aspect of the disclosure, entropy coding or statistical coding is applied. In the entropy coding or statistical coding, statistical compression and coding are performed on a quantized transform-domain signal according to a frequency at which each value appears, and finally a binary (0 or 1) compressed bitstream is outputted. Furthermore, for other information generated by coding, such as a selected coding mode and motion vector data, entropy coding is also required to reduce a bit rate. Statistical coding is a lossless coding mode, and may effectively reduce a bit rate required for expressing the same signal. A related statistical coding mode includes variable length coding (VLC) or context adaptive binary arithmetic coding (CABAC).

A context adaptive binary arithmetic coding (CABAC) process mainly includes 3 operations: binarization, context modeling, and binary arithmetic coding. After an input syntactic element is binarized, binary data may be coded by a related coding mode and a bypass coding mode. In the bypass coding mode, a probabilistic model needs not to be allocated to each binary bit, and an input binary bit bin value is directly coded by a simple bypass coder to accelerate coding and decoding. In an example, different syntactic elements may not be independent of each other, and the same syntactic element also has certain memorization. Therefore, according to a conditional entropy theory, conditional coding performed by using other coded syntactic elements can further improve the coding performance compared with independent coding or memoryless coding. The coded symbol information used as conditions is called a context. In a related coding mode, binary bits of a syntactic element sequentially enter a context modeler, and a coder allocates an appropriate probabilistic model to each input binary bit based on the value of a syntactic element or a binary bit that has been coded previously. This process is context modeling. A context model corresponding to the syntactic element may be located by using a context index increment (ctxIdxInc) and a context index start (ctxIdxStart). After the bin value and the allocated probabilistic model are both transmitted to a binary arithmetic coder for coding, the context model needs to be updated based on the bin value, i.e., an adaptive process during coding.

According to an aspect of the disclosure, loop filtering is applied. In the loop filtering, a reconstructed image is obtained by performing operations of inverse quantization, inverse transform, and predictive compensation on a changed and quantized signal. Compared with an original image, some information of the reconstructed image is different from that of the original image due to the influence of quantization, namely, the reconstructed image may have distortion. Therefore, a filtering operation may be performed on the reconstructed image, for example, using a filter such as a deblocking filter (DB), sample adaptive offset (SAO), or an adaptive loop filter (ALF), to effectively reduce the distortion degree caused by quantization. Because these filtered reconstructed images are used as reference for subsequent coded images for performing prediction on a future image signal, the foregoing filtering operation is also called loop filtering, namely, a filtering operation inside a coded loop.

In an embodiment of the disclosure, FIG. 3 shows a basic flowchart of a video coder. In the flowchart, intra prediction is used as an example for description. Difference operation is performed on an original image signal sₖ[x, y] and a predicted image signal ŝₖ[x, y] to obtain a residual signal uₖ[x, y]. After the residual signal uₖ[x, y] undergoes transform and quantization, a quantization coefficient is obtained. On one hand, entropy coding is performed on the quantization coefficient to obtain a coded bitstream, and on the other hand, inverse quantization and inverse transform are performed to obtain a reconstructed residual signal u′ₖ[x, y]. The predicted image signal ŝₖ[x, y] and the reconstructed residual signal u′ₖ[x, y] are superposed to generate an image signal s*ₖ[x, y]. On one hand, the image signal s*ₖ[x, y] is inputted into an intra prediction mode decision-making module and an intra prediction module and undergoes intra prediction, and on the other hand, a reconstructed image signal s′ₖ[x, y] is outputted through loop filtering. The reconstructed image signal s′ₖ[x, y] may be used as a reference image for the next frame for performing motion estimation and motion compensation prediction. Then, based on a result s′ᵣ[x+mₓ, y+m_{y}] of the motion compensation prediction, and an intra prediction result f(s*ₖ[x, y]), a predicted image signal ŝₖ[x, y] of the next frame is obtained and the above process is repeated until coding is completed.

Based on the above coding process, on a decoder side, for each coding unit (or coding block), after a compressed bitstream is acquired, entropy decoding is performed to obtain various pattern information and quantization coefficients. Then, inverse quantization and inverse transform are performed on the quantization coefficients to obtain a residual signal. On the other hand, according to known coding mode information, a predicted signal corresponding to the coding unit (or the coding block) may be obtained, and then a reconstructed signal may be obtained after the residual signal and the predicted signal are added. Then the reconstructed signal undergoes operations such as loop filtering, to generate a final output signal.

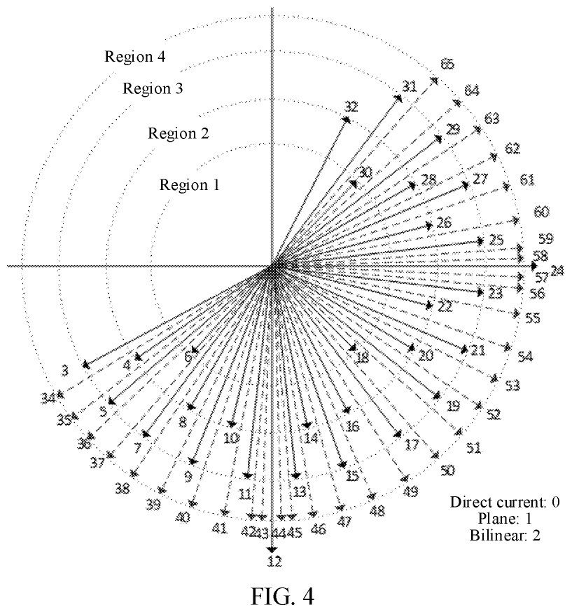

In the field of coding technologies, intra prediction is a related predictive coding technology. Intra prediction derives a predicted value of a current coding block from an adjacent coded region based on a correlation that exists in pixels of a video image in a space domain. A second stage of AVS3 adopts an extended intra prediction mode (EIPM). The previous-generation AVS2 has 33 intra prediction modes in total, including 30 angle prediction modes and 3 special prediction modes (a Plane prediction mode, a DC prediction mode, and a Bilinear prediction mode), coding is performed by using 2 most probable prediction modes (MPM), and 5-bit fixed-length coding is performed in the other modes. To support finer angle prediction, 62 angle prediction modes are extended in AVS3. As shown in FIG. 4, the numbers of the newly added angle prediction modes are 34 to 65.

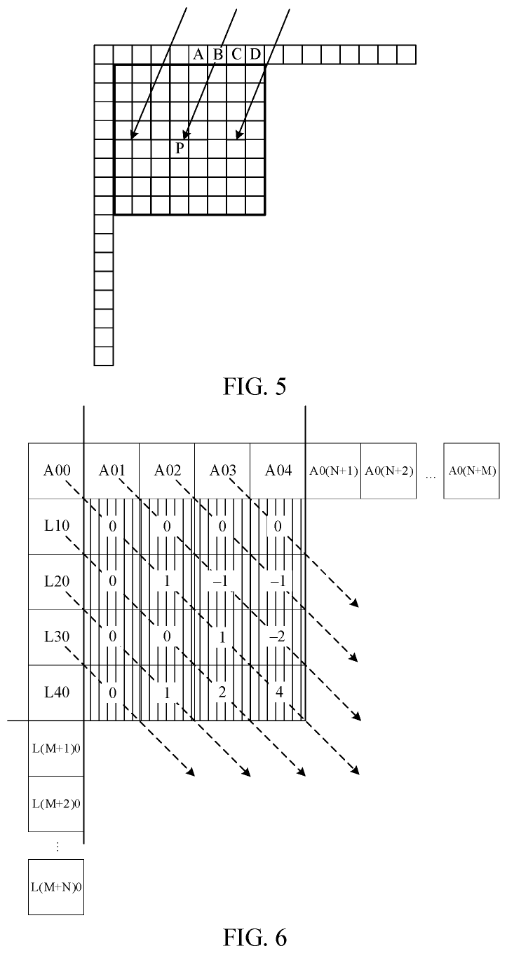

When an angle prediction mode is used, for pixels in a current prediction block, reference pixel values at corresponding positions on reference pixel lines or columns are used as predicted values according to a direction corresponding to an angle of the prediction mode. As shown in FIG. 5, for a pixel P in a prediction block, the position of a reference pixel is first determined from a top coded pixel line according to a prediction angle in the figure, and then the value of the reference pixel is used as a predicted value of the pixel P. Not all the reference pixel positions to which pixel positions point are of full pixel precision. For example, the reference pixel position of a pixel P in FIG. 5 is a discrete pixel position between pixels B and C, and therefore, the predicted pixel value of the position needs to be obtained through interpolation by using surrounding pixels. To improve the intra prediction efficiency, an on-chip memory is typically used to store reference pixels for intra prediction.

For a non-angle intra prediction mode, for example, a DC (average) prediction mode, surrounding adjacent reference pixels are averaged, and each position of a prediction block is filled with the average value.

Because the reference pixels are from the left and top regions of a current block, and pixels in the left or top regions of the current block are relatively close to the reference pixels, the pixels and the reference pixels have significant statistical correlation, and an absolute value of a prediction residual is small. For pixels in the bottom or right region of the current block, because the pixels are far from the reference pixels, an absolute value of a prediction residual is large. An intra prediction residual distribution in the disclosure may be shown in FIG. 6. The example shown in FIG. 6 is a residual example in a bottom-right 45-degree prediction direction. The filled region represents a current block, and the unfilled region represents a reference region of the current block. From FIG. 6, the prediction residual of a pixel sample at the bottom-right corner of the current block is 4, and is much greater than the prediction residual at the top-left corner.

An extrapolation filter based intra prediction EIP mode mainly defines an adjacent (top+left) reference region for a current block, and then performs weighted combination based on pixels in the reference region to generate predicted pixels of the current block. If a pixel position in the reference regions has not been reconstructed, predicted pixels of the position may be used to replace reconstructed pixels. Therefore, the EIP is a technology that may simultaneously and synchronously perform prediction at a plurality of positions in a current block.

In the EIP, an extrapolation filter coefficient of the reference region of the current block needs to be acquired, and the filter coefficient may be obtained by fitting a relationship between a template pixel and a target pixel in the adjacent reference region, or may be obtained by inheriting an extrapolation filter coefficient of a coded block.

In some aspects, when the filter coefficient in the EIP is fitted, the shape of the reference region (i.e., a reconstructed region to which the current block refers) and the shape of a filter template need to be determined. Then a selected filter is slid horizontally or vertically in a selected reference region to construct an autocorrelation matrix and a cross-correlation vector, and a filter coefficient is calculated based on the autocorrelation matrix and the cross-correlation vector. This process is similar to a process of determining a filter coefficient in a convolutional cross-component intra prediction model (CCCM). In an example, in the CCCM, the autocorrelation matrix is used to represent a correlation between luminance reconstruction pixels in the reference region, and the cross-correlation vector is used to represent a correlation between the luminance reconstruction pixels and chrominance reconstruction pixels in the reference region, and then mean square error (MSE) minimization is performed to solve the filter coefficient.

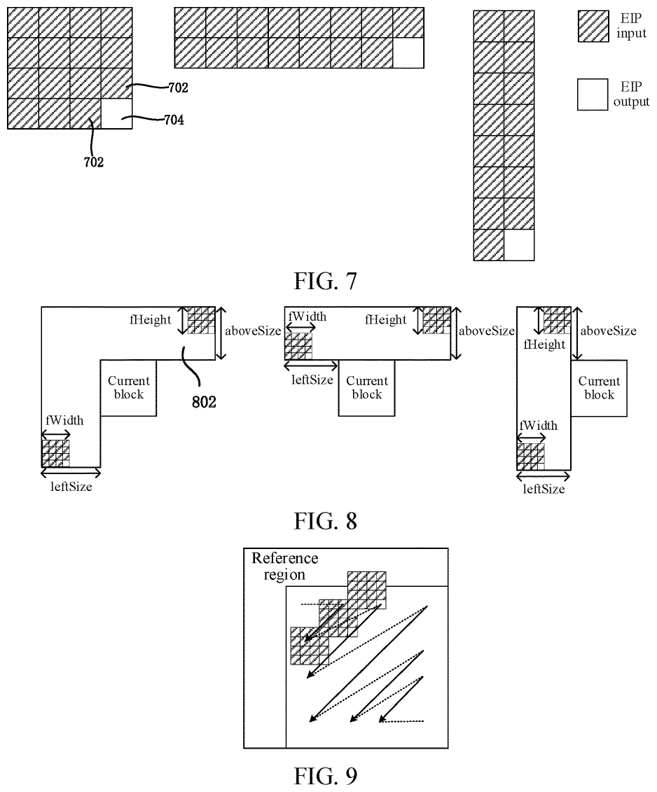

In some aspects, three shapes of filter templates (or filters) that may be used in the EIP are shown in FIG. 7, and three shapes of reference regions that may be used are shown in FIG. 8. In some aspects, the size of the reference regions depends on min (blockWidth, blockHeight) and the selected shape of a filter template. For example, if the size of the current block is 8×16 (i.e., the block Width is 8, and the blockHeight is 16), and the selected shape of a filter template is 4×4, the aboveSize of the reference region is min (8,16)+4−1=11, and the leftSize of the reference region is min (8,16)+4−1=11.

After the shape of the EIP filter template (or EIP filter) and the corresponding filter coefficient are obtained, predicted pixels generated based on the EIP mode may be constructed in the current block one by one at positions according to a certain scanning order, until predicted values of all pixels are generated. FIG. 9 shows a schematic diagram of generation of predicted pixels in a diagonal scanning order. In some aspects, a formula for generating the pixel predicted value at a certain position in the current block may be shown in equation (1) as follows:

$${pred}_{( x , y )} = {Σ}_{i = 0}^{14} ( {c}_{i} \times {t}_{( x - {offsetX}_{i} , y - {offsetY}_{i} )} ) \qquad Eq . ( 1 )$$

where pred_{(x,y)} represents the predicted pixel value at a coordinate position (x, y) in the current block; cᵢ represents a filter coefficient in a filter shape, and for the shapes of filter templates shown in FIG. 7, there are 15 filter coefficients in total; t_{(x-offsetX}_{ᵢ}_{,y-offsetY}_{ᵢ}₎ represents a reconstructed pixel value or the predicted pixel value in the filter template (if the reconstructed pixel value of the position is not obtained yet, the predicted pixel value may be used); and offsetXᵢ and offsetYᵢ represent position offsets to the current position (x, y) along the x direction and the y direction respectively.

Based on the above descriptions, for the current block using the EIP mode, the filter coefficient is derived by using the pixels in the reference region adjacent to the current block. Consequently, the prediction effect decreases as the pixels in the current block are far from the reference region. This affects more significantly a right/bottom region of the current block, further affects the accuracy of intra prediction, and reduces the coding and decoding efficiency. Based on the above, in the technical solutions provided in the aspects of the disclosure, for the current block using the extrapolation filter-based intra prediction mode, the filter coefficient of the reference region corresponding to the current block may be adjusted by using a compensation value for the filter coefficient, thereby optimizing the filter coefficient of the reference region corresponding to the current block, improving the accuracy of intra prediction, and helping improve the video coding and decoding efficiency.

The following describes implementation of the technical solutions in the aspects of the disclosure in further detail.

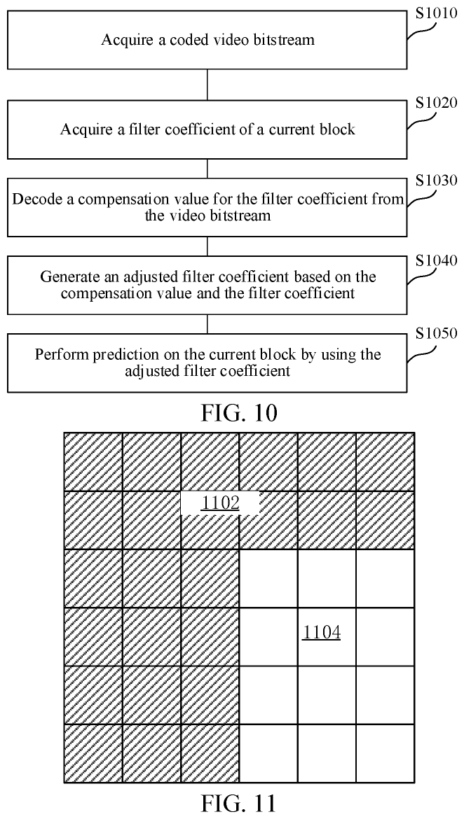

FIG. 10 shows a flowchart of a video decoding method according to an embodiment of the disclosure. The video decoding method may be performed by a device having a computing function, for example, a terminal device or a server. As shown in FIG. 10, the video decoding method includes at least S1010 to S1050. A description is as follows.

At S1010, a coded video bitstream is acquired.

At S1020, a filter coefficient of a current block is acquired. The filter coefficient may be applied in an extrapolation filter-based intra prediction mode. In other words, for a current block in an extrapolation filter-based intra prediction mode, acquire a filter coefficient of the current block.

In the extrapolation filter-based intra prediction (EIP) mode, predicted values of pixels (i.e., predicted pixel values) in a current block are predicted by using a filter. A filter in the EIP mode includes a plurality of input positions and one output position. In the EIP mode, weighted combination is performed on reconstructed pixel values (if not reconstructed, the reconstructed pixel values are replaced with predicted pixel values) of the plurality of input positions in the filter by using the coefficient of the filter, to determine a predicted pixel value of the output position. For example, in FIG. 7, each filled block corresponds to an input position, and each unfilled block corresponds to an output position. In some aspects, a video includes a sequence of video image frames, the sequence of video image frames includes a series of images, each image may be further partitioned into slices, the slices may further be partitioned into a series of LCUs (or CTUs), and an LCU includes several CUs. A video image frame is coded by using block as a unit. In some new video coding standards, for example, an H.264 standard includes a macroblock (MB), and the macroblock may be further partitioned into a plurality of prediction blocks that may be used for predictive coding. In an HEVC standard, basic concepts of a coding unit (CU), a prediction unit (PU), and a transform unit (TU) are used to partition a plurality of block units in function, and a new tree-based structure is used for description. For example, the CU may be partitioned into smaller CUs according to a quadtree, and a smaller CU may further be partitioned, to form a quadtree structure. The current block, reference block, and adjacent block in the aspects of the disclosure may be CUs or blocks smaller than the CUs, for example, smaller blocks obtained by partitioning a CU.

In some aspects, when the filter coefficient of the current block is obtained, the filter coefficient of the decoded block may be used as the filter coefficient of the current block, i.e., the filter coefficient of the current block may be obtained by inheriting the filter coefficient of the decoded block.

In some aspects, when the filter coefficient of the current block is obtained, the filter coefficient of the current block may be determined based on the reconstructed pixels or predicted pixels in the reference region adjacent to the current block.

In some aspects, the reference region may include at least one of a left region adjacent to the current block or a top region adjacent to the current block. The shape of the reference region may be, for example, one of the 3 shapes of the reference region in FIG. 8. The size of the reference regions depends on min (blockWidth, blockHeight) and the shape of a selected filter. The shape of the filter may be rectangular. The shape of the filter is, for example, one of the filter templates in 3 shown in FIG. 7. For example, if the size of the current block is 8×16 (i.e., the blockWidth is 8, and the blockHeight is 16), and the shape of the selected filter is 4×4, then the aboveSize of the reference region is min (8,16)+4−1=11, and the leftSize of the reference region is min (8,16)+4−1=11.

In some aspects, to determine the filter coefficient in the EIP, in the aspects of the disclosure, first the shapes of the reference region and the filter are selected based on the related syntactic element from the video bitstream. Here, the related syntactic element may indicate the type of the reference region and the shape of the filter. For example, the first syntactic element indicates the type of the reference region, and the second syntactic element indicates the shape of the filter.

Then, in the aspects of the disclosure, the selected filter is slid horizontally or vertically in the selected reference region to construct the autocorrelation matrix and the cross-correlation vector, and the filter coefficient is calculated based on the autocorrelation matrix and the cross-correlation vector. For example, the filter coefficient may be calculated according to the following Wiener-Hopf equation as shown in equation (2):

$$R 1 \cdot w 1 = p 1 \qquad Eq . ( 2 )$$

where R1 represents an autocorrelation matrix of reconstructed pixel values of a reference subblock, p1 represents a cross-correlation vector of the reconstructed pixel values of the reference subblock and a target pixel value, and w1 represents the filter coefficient to be solved. In an example, the reconstructed pixel values of the reference subblock are reconstructed pixel values of a reference region (e.g., reference region (802)) in the input positions (e.g., positions (702)) of the filter (or filter template). The target pixel value is a reconstructed pixel value of the reference region in the output position (e.g., position (704)) of the filter. In the aspects of the disclosure, the filter coefficient may be determined by minimizing a mean square error (MSE) of prediction based on the autocorrelation matrix and the cross-correlation vector of the reconstructed pixel values of the reference subblock. For each sliding position in the sliding process, the reconstructed pixel values of the reference subblock (e.g., a block formed by pixels at a plurality of input positions (e.g., input positions (702)) of the filter) of the filter and the target pixel value (e.g., the reconstructed pixel value at an output position (e.g., output position (704) of the filter) may be determined. Based on equation (2), a respective filter coefficient w1 can be accordingly determined. Based on the EIP mode, a prediction pixel value at the output position can be determined based on equation (1). A respective MSE can be determined based on the reconstructed pixel value at the output position and the prediction pixel value at the output position. Further, the filter coefficient w1 that corresponds to a minimum MSE can be selected to predict the current block.

At S1030, a compensation value for the filter coefficient is decoded from the video bitstream.

In some aspects, a process of decoding the compensation value for the filter coefficient from the video bitstream may be: decoding an absolute value and a symbol corresponding to the compensation value from the video bitstream; and determining the compensation value for the filter coefficient based on the absolute value and the symbol.

In some aspects, entropy coding may be performed on the absolute value corresponding to the compensation value for the filter coefficient by context adaptive binary arithmetic coding. For example, in a sequence of absolute values corresponding to a plurality of filter coefficients, the value of an i^{th} bit in a bit string configured for representing one absolute value in the sequence may be used as a context of the value of an i^{th} bit in a bit string configured for representing a neighboring latter absolute value in the sequence, where i is less than or equal to a bit string length configured for representing an absolute value. In the technical solution of this embodiment, the correlation between the absolute values may be used to improve the coding efficiency.

In some aspects, the process of decoding the compensation value for the filter coefficient from the video bitstream may be: decoding an index of the compensation value from the video bitstream; and determining the compensation value in a preset compensation value list based on the index. In some aspects, the preset compensation value list may include absolute values of compensation values, and the symbols need to be separately indicated otherwise; or the preset compensation value list may include both the absolute values of the compensation values and the symbols of the compensation values.

At S1040, the adjusted filter coefficient is generated based on the compensation value and the filter coefficient.

At S1050, prediction is performed on the current block by using the adjusted filter coefficient.

For the current block using the EIP mode, the filter coefficient is derived by using the pixels in the reference region adjacent to the current block. Consequently, the prediction effect decreases as the pixels in the current block are far from the reference region. This affects more significantly a right/bottom region of the current block, further affects the accuracy of intra prediction, and reduces the coding and decoding efficiency. Based on the above, in the technical solutions provided in the aspects of the disclosure, for the current block using the extrapolation filter-based intra prediction mode, the filter coefficient of the reference region corresponding to the current block may be adjusted by using a compensation value for the filter coefficient, thereby optimizing the filter coefficient of the reference region corresponding to the current block, improving the accuracy of intra prediction, and helping improve the video coding and decoding efficiency. In some aspects, a process of generating the adjusted filter coefficient based on the compensation value and the filter coefficient may be: adjusting the filter coefficient by using the compensation value to obtain the adjusted filter coefficient. In this case, intra prediction may be performed on a specified region in the current block by using the adjusted filter coefficient, such as c_{i_final} in equation (4).

In some aspects, in operation S1050, the predicted values of pixels at positions in the current block may be generated in equation (3) as follows:

$${pred}_{( x , y )} = {Σ}_{i = 0}^{14} ( {c}_{i} \times {t}_{( x - {offsetX}_{i} , y - {offsetY}_{i} )} ) \qquad Eq . ( 3 )$$

where pred_{(x,y)} represents the predicted pixel value at a coordinate position (x, y) in the current block; and cᵢ represents an adjusted filter coefficient in the filter shape. For the shapes of the filter templates shown in FIG. 7, there are 15 filter coefficients in total. t_{(x-offsetX}_{ᵢ}_{,y-offsetY}_{ᵢ}₎ represents a reconstructed pixel value or the predicted pixel value in the filter template (if the reconstructed pixel value of the position is not obtained yet, the predicted pixel value may be used to replace the reconstructed pixel value); and offsetXᵢ and offsetYᵢ represent position offsets to the current position (x, y) along the x direction and the y direction respectively.

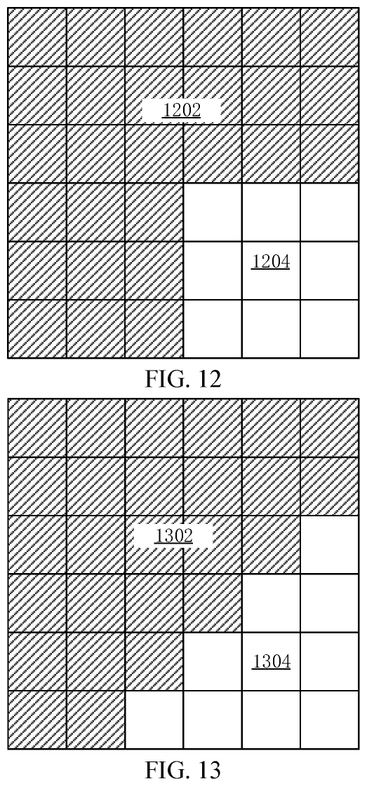

In some aspects, the specified region in the current block may be the entire region in the current block, or may be a partial region in the current block. If the specified region (or a second region) is a partial region in the current block, intra prediction may be performed on regions (or first regions) other than the specified region (or second region) in the current block by using the filter coefficient (i.e., an unadjusted filter coefficient, such as c_{i_derived} in equation (4)) of the reference region corresponding to the current block. As shown in FIG. 11, a specified region (or second region) is a region (1104) and a first region is a region (1102). In FIG. 12, a specified region (or second region) is a region (1204) and a first region is a region (1202). In FIG. 13, a specified region (or second region) is a region (1304) and a first region is a region (1302).

In an example, the specified region (or second region) may include: regions other than first top M rows and first left N columns in the current block, where 0≤M≤a number of rows of the current block; and 0≤N≤a number of columns of the current block. For example, in the example shown in FIG. 11, the specified region (1104) is a non-filled region in the figure, M is 2, and N is 3.

If M is 0 and N is not 0, the specified region may be a region other than the left N columns in the current block. If M is not 0, and N is 0, the specified region may be a region other than the top M rows in the current block.

In a specific example, the specified region may include: regions other than first top H/T rows and first left W/S columns in the current block, where H represents a number of rows of the current block, W represents a number of columns of the current block, and T and S represent 2 raised to the power of a positive integer. For example, in the example shown in FIG. 12, the specified region (1204) is the non-filled region in the figure, H=W=6, T=S=2, namely, 2 raised to the power of 1.

The specified region may also include a region other than the top H/T rows in the current block, or the specified region may include a region other than the left W/S columns in the current block.

In a specific example, the specified region may include: a bottom-right corner region obtained by partitioning the current block in a direction from top right to bottom left. In some aspects, the area of the bottom-right corner region obtained by partitioning the current block in the direction from top right to bottom left may be the same as or different from the area of the top-left corner. For example, in the example shown in FIG. 13, the specified region (1304) is the non-filled region in the figure.

In other aspects of the disclosure, the specified region may also be a combination of the regions shown in the foregoing aspects. In the aspects of the disclosure, the specified region is set to the bottom right, the right, or the bottom of the current block as much as possible, mainly considering that the pixels close to the right and the bottom of the current block are far from the reference region of the current block. Thus, the prediction effect may decrease as the pixels in the current block are far from the reference region, and the accuracy of intra prediction may be affected. These problems may be avoided by optimizing the filter coefficient of the reference region corresponding to the specified region to ensure the accuracy of intra prediction.

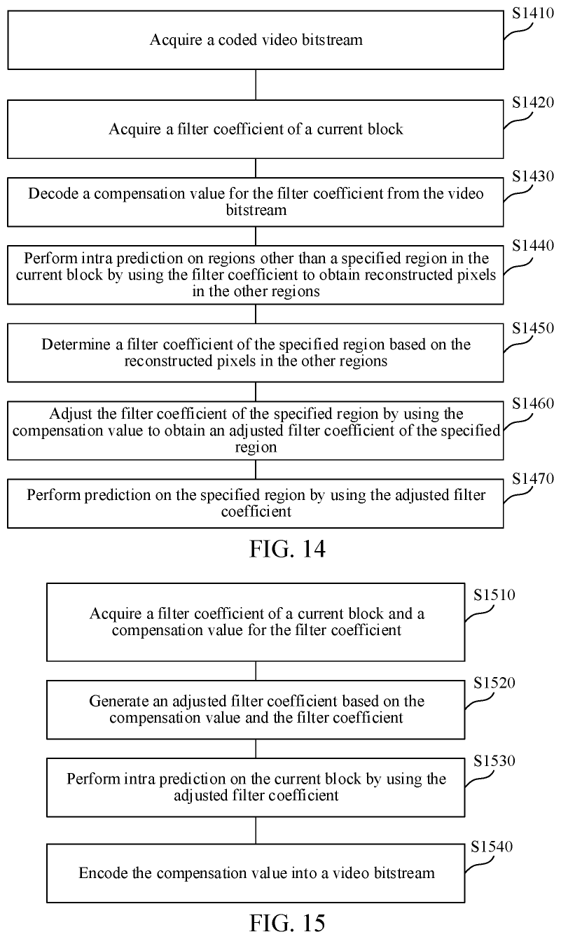

In some aspects, S1040 and S1050 shown in FIG. 10 may have other implementations. In an example, when the adjusted filter coefficient is generated based on the compensation value and the filter coefficient, intra prediction may be performed on regions other than the specified region in the current block by using the filter coefficient to obtain predicted pixels in the other regions, thereby obtaining reconstructed pixels. Then, a filter coefficient of the specified region is determined based on the reconstructed pixels in the other regions. For example, the reconstructed pixels in the other regions are used as pixels in the reference region corresponding to the specified region, a filter coefficient corresponding to the specified region is determined, and then the filter coefficient corresponding to the specified region is adjusted by using the compensation value to obtain the adjusted filter coefficient. Here, the filter coefficient is determined in the same mode as determining the filter coefficient by using the Wiener-Hopf equation. In other words, in this embodiment, intra prediction may be performed on the regions other than the specified region by using the filter coefficient of the reference region corresponding to the current block. After the reconstructed pixels are obtained, the filter coefficient of the specified region in the current block may be determined by using the solution described in the foregoing aspects, so that the filter coefficient of the specified region can be more adaptive to the pixels in the specified region. Further, after the filter coefficient of the reference region of the specified region is adjusted by using the compensation value, intra prediction may be performed on the specified region by using the adjusted filter coefficient. FIG. 14 shows a specific process of this embodiment, including S1410 to S1470.

At S1410, a coded video bitstream is acquired.

At S1420, a filter coefficient of a current block is acquired. The filter coefficient may be applied in an extrapolation filter-based intra prediction mode.

In some aspects, for implementation details of S1420, a reference may be made to the descriptions for S1020 in the foregoing aspects, and details thereof are omitted herein.

At S1430, a compensation value for the filter coefficient is decoded from the video bitstream.

In some aspects, for implementation details of S1430, a reference may be made to the descriptions for S1030 in the foregoing aspects, and details thereof are omitted herein.

At S1440, intra prediction is performed on regions other than the specified region in the current block by using the filter coefficient to obtain reconstructed pixels in the other regions.

In some aspects, the specified region may also be regions shown in the foregoing aspects, for example, the regions shown in FIG. 11 to FIG. 13. In this embodiment, the acquired filter coefficient of the reference region corresponding to the current block may be configured to perform intra prediction on the regions other than the specified region in the current block.

At S1450, a filter coefficient of the specified region is determined based on the reconstructed pixels in the other regions.

In some aspects, the filter coefficient of the specified region in the current block may be determined by using the solution described in the foregoing aspects.

At S1460, the filter coefficient of the specified region is adjusted by using the compensation value to obtain an adjusted filter coefficient of the specified region.

At S1470, prediction is performed on the specified region by using the adjusted filter coefficient.

In the embodiment shown in FIG. 14, prediction may be performed on a partial region in the current block by using the filter coefficient of the current block, and then the filter coefficient of the specified region is re-determined based on the prediction result, so that the filter coefficient of the specified region can be more adaptive to the pixels in the specified region. Further, after the filter coefficient of the specified region is adjusted by using the compensation value, intra prediction may be performed on the specified region by using the adjusted filter coefficient. Thus, the filter coefficient of the specified region may be optimized, thereby improving the accuracy of intra prediction.

The execution sequences of the operations shown in FIG. 10 and FIG. 14 are merely examples. In other aspects of the disclosure, the execution sequences of the operations may be reversed. For example, S1430 may be performed after S1440, or may be performed after S1450.

FIG. 10 and FIG. 14 illustrate the technical solutions in the aspects of the disclosure from the perspective of video decoding. The following describes the technical solutions in the aspects of the disclosure from the perspective of video coding with reference to FIG. 15.

FIG. 15 shows a flowchart of a video coding method according to an embodiment of the disclosure. The video coding method may be performed by a device having a computing function, for example, a terminal device or a server. As shown in FIG. 15, the video coding method includes at least S1510 to S1540. A description is as follows.

At S1510, a filter coefficient of a current block and a compensation value for the filter coefficient are acquired. The filter coefficient may be applied in an extrapolation filter-based intra prediction mode. In other words, for a current block in an extrapolation filter-based intra prediction mode, a filter coefficient of the current block and a compensation value for the filter coefficient are acquired.

At S1520, an adjusted filter coefficient is generated based on the compensation value and the filter coefficient.

At S1530, intra prediction is performed on the current block by using the adjusted filter coefficient.

At S1540, the compensation value is encoded into a video bitstream.

A processing process of a video coder side is similar to a processing process of the video decoder side, a reference may be made to the foregoing processing process related to the decoder side, and descriptions thereof are omitted herein.

In technical solutions in the aspects of the disclosure, the prediction precision of the EIP mode may be improved by optimizing the value of the filter coefficient of the EIP mode, thereby reducing a prediction residual of an entire block, and improving the coding and decoding efficiency. In an example, an actual filter coefficient (or adjusted filter coefficient) used in the reference region of the current block may be expressed as c_{i_final}, a filter coefficient (or a derived filter coefficient) of the current block determined based on reconstructed pixels or obtained by inheriting from the reconstructed pixels may be expressed as c_{i_derived}, the compensation value for the filter coefficient may be expressed as c_{i_delta}, and then, c_{i_final} may be provided as follows in equation (4)

$${c}_{i\_final} = {c}_{i\_derived} + {c}_{i\_delta} \qquad Eq . ( 4 )$$

In some aspects, on a coder side, c_{i_final} may be derived by using true values of pixels in the reference region, or may be acquired by inheriting a filter coefficient of a coded block.

In some aspects, the actual filter coefficient used by the reference region of the current block is acquired as follows:

To determine the actual filter coefficient used in the reference region, in the aspects of the disclosure, the selected filter is slid horizontally or vertically in the reference region to construct an autocorrelation matrix and a cross-correlation vector, and then the filter coefficient is calculated based on the autocorrelation matrix and the cross-correlation vector. For example, the filter coefficient may be calculated in equation (5) according to the following Wiener-Hopf equation:

$$R 2 \cdot w 2 = p 2 \qquad Eq . ( 5 )$$

where R2 represents an autocorrelation matrix of pixel true values of a reference subblock, p represents a cross-correlation vector of the pixel true values of the reference subblock and the pixel true value of a target pixel, and w represents the filter coefficient to be solved. In the aspects of the disclosure, the filter coefficient may be determined by minimizing a mean square error (MSE) of prediction based on the autocorrelation matrix and the cross-correlation vector. For each sliding position in the sliding process, the pixel true values of the reference subblock (i.e., a block formed by pixels at a plurality of input positions of the filter) of the filter and the pixel true value of the target pixel (i.e., the pixel at an output position of the filter) may be determined.

In some aspects, c_{i_derived} is determined as follows in equation (6):

$$R 1 \cdot w 1 = p 1 \qquad Eq . ( 6 )$$

where R1 represents an autocorrelation matrix of reconstructed pixel values of a reference subblock, p1 represents a cross-correlation vector of the reconstructed pixel values of the reference subblock and a target pixel value, and w1 represents the filter coefficient to be solved. In the aspects of the disclosure, the filter coefficient may be determined by minimizing a mean square error (MSE) of prediction based on the autocorrelation matrix and the cross-correlation vector of the reconstructed pixel values of the reference subblock. For each sliding position in the sliding process, the reconstructed pixel values of the reference subblock (i.e., a block formed by pixels at a plurality of input positions of the filter) of the filter and the target pixel value (i.e., the reconstructed pixel value at an output position of the filter) may be determined.

After the actual filter coefficient used in the reference region of the current block and the filter coefficient of the current block are determined on the coder side, the compensation value may be determined by calculating the difference between the actual filter coefficient and the filter coefficient of the current block. The adjusted filter coefficient obtained at the decoder side may be used to represent the actual filter coefficient used in the reference region of the current block.

In some aspects, to indicate c_{i_delta}, a quantization mode may be used, and a fixed bit length may be used for identification. For example, an absolute value is identified by a fixed 4 bit length and is in a range of [0,0.5], and a symbol is indicated by using 1 bit.

In some aspects, when entropy coding performed on an absolute value of c_{i_delta} is represented by binarization of a bit string, a CABAC context model may be designed for the value of an i^{th} bit (i=1, 2, . . . ) in the bit string. For example, the value of an i^{th} bit in a bit string of the absolute value of the previous c_{i_delta} is used as the context of the value in an i^{th} bit in a bit string of the absolute value of the current c_{i_delta}.

In some aspects, to indicate c_{i_delta}, table look-up may be used, and then an index is added to the bitstream for indication, for example, a relationship table including symbols as shown in Table 1, or a relationship table not including symbols as shown in Table 2.

TABLE 1
A look-up table for cᵢ_delta

| Index | 0 | 1 | 2 | 3 | 4 | 5 | 6 | 7 | 8 |
|---|---|---|---|---|---|---|---|---|---|
| cᵢ_delta | 0 | 1/16 | − 1/16 | ⅛ | −⅛ | ¼ | −¼ | ½ | −½ |
| Bit | 0 | 10 | 110 | 1110 | 11110 | 111110 | 1111110 | 111111110 | 111111110 |
| string | | | | | | | | | |

In Table 1, c_{i_delta} including a symbol may be indicated by an index.

TABLE 2
A look-up table for cᵢ_{_{—}}_{delta}

| Index | 0 | 1 | 2 | 3 | 4 |
|---|---|---|---|---|---|
| cᵢ_{_{—}}_{delta} | 0 | 1/16 | ⅛ | ¼ | ½ |
| Bit string | 0 | 10 | 110 | 1110 | 1111 |

In Table 2, c_{i_delta} without a symbol may be indicated by an index, and the symbol may need to be indicated otherwise.

In some aspects, the actual filter coefficient c_{i_final} used in the reference region of the current block in the EIP mode may be used as the filter coefficient on all pixels of the current block, or on partial pixels of the current block. For example, the current block may be partitioned into 2 regions, EIP mode prediction is performed on pixels of one of the regions by using the coefficient c_{i_final}, and EIP mode prediction is performed on pixels of the other region by using the coefficient c_{i_derived}.

In some aspects, for the first M rows of pixels and the first N columns of pixels (e.g., the filled region in FIG. 11) of the current block (W columns× H rows), EIP mode prediction is performed by using the coefficient c_{i_derived}. EIP mode prediction is performed on the other pixels (e.g., the non-filled region as shown in FIG. 11) by using the coefficient c_{i_final} M and N are positive integers, where 0≤M≤H, and 0≤N≤W.

In some aspects, for the first H/T rows of pixels and the first W/S columns of pixels (e.g., the filled region in FIG. 12) of the current block (W columns× H rows), EIP mode prediction is performed by using the coefficient c_{i_derived}. EIP mode prediction is performed on the other pixels (e.g., the non-filled region as shown in FIG. 12) by using the coefficient c_{i_final}. T and S are 2 raised to the power of a positive integer, such as 2 and 4.

In some aspects, the current block (W columns× H rows) is partitioned in a direction from top right to bottom left, to generate a top-left corner region (e.g., a filled region in FIG. 13) and a bottom-right corner region (e.g., a non-filled region in FIG. 13), the areas of which may be the same or different. EIP mode prediction is performed on the top left corner region by using the coefficient c_{i_derived}; and EIP mode prediction is performed on the other pixels by using the coefficient c_{i_final}.

In some aspects, the current block may be partitioned into 2 regions, EIP mode prediction is performed on pixels of a first region by using the coefficient c_{i_derived}, and then the filter coefficient is derived by fitting based on the reconstructed pixels of the first region. The actual filter coefficient value c_{i_delta} is obtained by adjustment through c_{i_final}, and then c_{i_final} is used as the filter coefficient of pixels in a second region.

In some aspects, for the first M rows of pixels and the first N columns of pixels (e.g., the filled region in FIG. 11) of the current block (W columns× H rows), EIP mode prediction is performed by using the coefficient c_{i_derived}. EIP mode prediction is performed on the other pixels (e.g., the non-filled region as shown in FIG. 11) by using the coefficient c_{i_final}. M and N are positive integers, where 0≤M≤H, and 0≤N≤W.

In some aspects, for the first H/T rows of pixels and the first W/S columns of pixels (e.g., the filled region in FIG. 12) of the current block (W columns× H rows), EIP mode prediction is performed by using the coefficient c_{i_derived}. EIP mode prediction is performed on the other pixels (e.g., the non-filled region as shown in FIG. 12) by using the coefficient c_{i_final}. T and S are 2 raised to the power of a positive integer, such as 2 and 4.

In some aspects, the current block (W columns× H rows) is partitioned in a direction from top right to bottom left, to generate a top-left corner region (e.g., a filled region in FIG. 13) and a bottom-right corner region (e.g., a non-filled region in FIG. 13), the areas of which may be the same or different. EIP mode prediction is performed on the top left corner region by using the coefficient c_{i_derived}; and EIP mode prediction is performed on the other pixels by using the coefficient c_{i_final}.

An apparatus example of the disclosure is described below, which may be configured to perform the methods in the foregoing aspects of the disclosure. For details not disclosed in the apparatus embodiment of the disclosure, a reference may be made to the forgoing method examples of the disclosure.

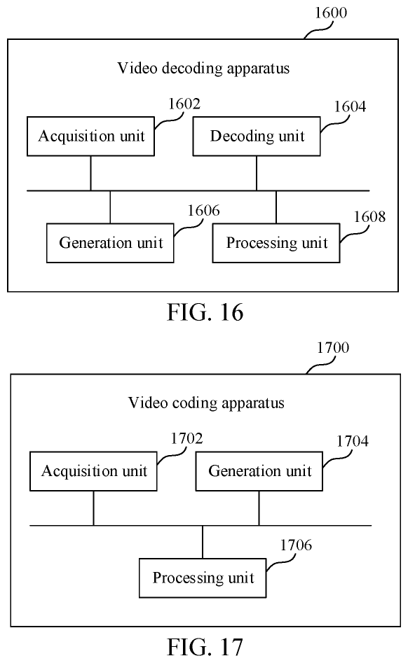

FIG. 16 shows a block diagram of a video decoding apparatus according to an embodiment of the disclosure. The video decoding apparatus may be arranged in a device having a computing function, for example, in a terminal device or a server.

As shown in FIG. 16, a video decoding apparatus 1600 according to an embodiment of the disclosure includes an acquisition unit 1602, a decoding unit 1604, a generation unit 1606, and a processing unit 1608.

The acquisition unit 1602 is configured to acquire a coded video bitstream, and acquire a filter coefficient of a current block, the filter coefficient being configured for an extrapolation filter-based intra prediction mode. The decoding unit 1604 is configured to decode a compensation value for the filter coefficient from the video bitstream. The generation unit 1606 is configured to generate an adjusted filter coefficient based on the compensation value and the filter coefficient. The processing unit 1608 is configured to perform prediction on the current block by using the adjusted filter coefficient.

In some aspects of the disclosure, based on the foregoing solution, the decoding unit 1604 is configured to: decode an absolute value and a symbol corresponding to the compensation value from the video bitstream; and determine the compensation value based on the absolute value and the symbol.

In some aspects of the disclosure, based on the foregoing solution, entropy coding is performed on the absolute value by context adaptive binary arithmetic coding. In a sequence of absolute values corresponding to a plurality of filter coefficients, the value of an i^{th} bit in a bit string configured for representing one absolute value in the sequence may be used as a context of the value of an i^{th} bit in a bit string configured for representing a neighboring latter absolute value in the sequence, where i is less than or equal to a bit string length configured for representing an absolute value.

In some aspects of the disclosure, based on the foregoing solution, the decoding unit 1604 is configured to: decode an index of the compensation value from the video bitstream; and determine the compensation value in a preset compensation value list based on the index.

In some aspects of the disclosure, based on the foregoing solution, the generation unit 1606 is configured to: adjust the filter coefficient by using the compensation value to obtain the adjusted filter coefficient. The processing unit 1608 is configured to: perform prediction on a specified region in the current block by using the adjusted filter coefficient.

In some aspects of the disclosure, based on the foregoing solution, the processing unit 1608 is further configured to: perform prediction on regions other than the specified region in the current block by using the filter coefficient of the current block if the specified region is a partial region in the current block.

In some aspects of the disclosure, based on the foregoing solution, the generation unit 1606 is configured to: perform intra prediction on regions other than the specified region in the current block by using the filter coefficient to obtain reconstructed pixels in the other regions; determine a filter coefficient of the specified region based on the reconstructed pixels in the other regions; and adjust the filter coefficient of the specified region by using the compensation value to obtain an adjusted filter coefficient of the specified region. The performing prediction on the current block by using the adjusted filter coefficient includes: performing prediction on the specified region by using the adjusted filter coefficient.

In some aspects of the disclosure, based on the foregoing solution, the specified region includes: regions other than first top M rows and first left N columns in the current block, where 0≤M≤a number of rows of the current block; and 0≤N≤a number of columns of the current block.

In some aspects of the disclosure, based on the foregoing solution, the specified region includes: regions other than first top H/T rows and first left W/S columns in the current block, where H represents a number of rows of the current block, W represents the number of columns of the current block, and T and S represent 2 raised to the power of a positive integer.

In some aspects of the disclosure, based on the foregoing solution, the specified region includes: a bottom-right corner region obtained by partitioning the current block in a direction from top right to bottom left.

In some aspects of the disclosure, based on the foregoing solution, the acquisition unit 1602 is configured to: determine the filter coefficient of the current block based on reconstructed pixels or predicted pixels in a reference region adjacent to the current block; or use a filter coefficient of a decoded block as the filter coefficient of the current block.

FIG. 17 shows a block diagram of a video coding apparatus according to an embodiment of the disclosure. The video coding apparatus may be arranged in a device having a computing function, for example, in a terminal device or a server.

As shown in FIG. 17, a video coding apparatus 1700 according to an embodiment of the disclosure includes an acquisition unit 1702, a generation unit 1704, and a processing unit 1706.

The acquisition unit 1702 is configured to acquire a filter coefficient of a current block and a compensation value for the filter coefficient, the filter coefficient being configured for an extrapolation filter-based intra prediction mode. The generation unit 1704 is configured to generate an adjusted filter coefficient based on the compensation value and the filter coefficient. The processing unit 1706 is configured to perform intra prediction on the current block by using the adjusted filter coefficient, and code the compensation value into a video bitstream.

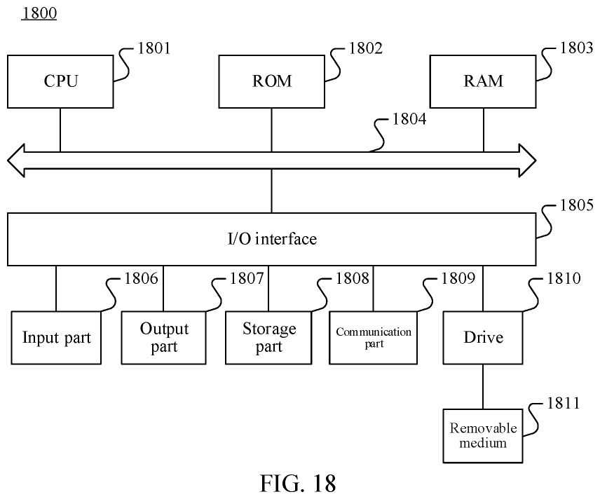

FIG. 18 shows a schematic structural diagram of a computer system adapted to implement an electronic device according to an embodiment of the disclosure, and the electronic device may be the video coding apparatus or the video decoding apparatus according to the foregoing aspects.

A computer system 1800 of the electronic device shown in FIG. 18 is merely an example, and does not constitute any limitation on the function and scope of use of the aspects of the disclosure.

As shown in FIG. 18, the computer system 1800 may include a central processing unit (CPU) 1801, which may perform various suitable actions and processes based on a program stored in a read-only memory (ROM) 1802 or a program loaded from a storage part 1808 into a random access memory (RAM) 1803, for example, to perform the method according to the forgoing aspects. The RAM 1803 further has various programs and data stored therein for system operation. The CPU 1801, the ROM 1802, and the RAM 1803 are connected to each other through a bus 1804. An input/output (I/O) interface 1805 is also connected to the bus 1804.

The following components may be connected to the I/O interface 1805: an input part 1806 including a keyboard and a mouse; an output part 1807 including a cathode ray tube (CRT), a liquid crystal displays (LCD), and a speaker; a storage part 1808 including a hard drive; and a communication part 1809 of a network interface card including a local area network (LAN) card, and a modem. The communication part 1809 performs communication processing through a network such as the Internet. A drive 1810 is also connected to the I/O interface 1805 as required. A removable medium 1811 such as a magnetic disk, an optical disk, a magneto-optical disk, or a semiconductor memory is installed on the drive 1810 as required, so that a computer program read from the removable medium is installed into the storage part 1808 as required.

In an example, according to the aspects of the disclosure, the process described above with reference to the flowchart may be implemented as a computer software program. For example, an embodiment of the disclosure includes a computer program product, the computer program product including a computer program carried on a computer-readable medium, the computer program being configured for performing the method shown in the flowchart. In such an embodiment, the computer program may be downloaded from a network through the communication part 1809 and installed, and/or installed from the removable medium 1811. The computer program, when executed by the central processing unit (CPU) 1801, performs various functions defined in the system of the disclosure.

The computer-readable medium according to the aspects of the present disclosure may be a computer-readable signal medium or a computer-readable storage medium, or any combination of the two. The computer-readable storage medium may be, for example, but is not limited to, an electric, magnetic, optical, electromagnetic, infrared, or semi-conductive system, apparatus, or device, or any combination of the above. More specific examples of the computer-readable storage medium may include, but are not limited to: an electrical connection having one or more wires, a portable computer disk, a hard disk, a random access memory (RAM), a read-only memory (ROM), an erasable programmable ROM (EPROM), a flash memory, an optical fiber, a portable compact disc read-only memory (CD-ROM), an optical storage device, a magnetic storage device, or any appropriate combination of the above. In the disclosure, the computer-readable storage medium may be any tangible medium including or storing a computer program, and the computer program may be used by or in combination with an instruction execution system, apparatus, or device. In the disclosure, a computer-readable signal medium may include a data signal being in a baseband or being propagated as a part of a carrier wave, the data signal carrying the computer-readable computer program. The data signal propagated in such a mode may assume a plurality of forms, including, but not limited to, an electromagnetic signal, an optical signal, or any suitable combination of the above. The computer-readable signal medium may further be any computer-readable medium other than the computer-readable storage medium, and the computer-readable medium may transmit, propagate, or transmit a program used by or in combination with the instruction execution system, apparatus, or device. The computer program included in the computer-readable medium may be transmitted by using any suitable medium, including, but not limited to: a wireless or wired medium, or any suitable combination of the above.

The flowcharts and block diagrams in the accompanying drawings illustrate the possible implementation architecture, functions, and operations of the system, method, and computer program product according to various aspects of the present disclosure. Each block in the flowcharts or the block diagrams may represent a module, a program segment, or a part of code, and the module, the program segment, or the part of the code includes one or more executable instructions for implementing specified logical functions. In some alternative implementations, functions annotated in the blocks may also be executed in an order different from those annotated in the accompanying drawings. For example, two boxes shown in succession may actually be performed substantially in parallel, and sometimes the two boxes may be performed in a reverse order, which depends on the functions involved. Each box in the block diagrams or flowcharts and combinations of the boxes in the block diagrams or flowcharts may be implemented by a dedicated hardware-based system that performs specified functions or operations, or may be implemented by a combination of dedicated hardware and a computer program.

Units described in the aspects of the disclosure may be implemented in the form of software, or may be implemented in the form of hardware, or the described units may be arranged in a processor. The names of these units do not constitute a limitation on the units in a case.

According to another aspect, the disclosure further provides a computer-readable medium, and the computer-readable medium may be included in the electronic device described in the foregoing aspects, or exist alone and is not assembled in the electronic device. The computer-readable medium carries one or more computer programs, and the one or more computer programs, when executed by the electronic device, cause the electronic device to implement the methods according to the foregoing aspects.

Although a plurality of modules or units of a device configured to perform actions are mentioned in the foregoing detailed description, such division is not mandatory. In fact, according to the implementations of the disclosure, the features and functions of two or more modules or units described above may be embodied in one module or unit. On the contrary, the features and functions of one module or unit described above may further be divided to be embodied by a plurality of modules or units.

Through the foregoing descriptions of the implementations, a person skilled in the art may readily understand that the implementations described herein may be implemented by software, or may be implemented by combining software with necessary hardware. Therefore, the technical solutions according to the implementations of the disclosure may be embodied in the form of a software product, and the software product may be stored in a non-volatile storage medium (which may be a CD-ROM, a USB flash drive, a removable hard disk, or the like) or on a network, and include several instructions for enabling an electronic device to perform the methods according to the implementations of the disclosure.

For example, the electronic device may be a video decoding apparatus, and then the video decoding apparatus may perform the video decoding method shown in FIG. 10 or FIG. 14. For another example, the electronic device may be a video coding apparatus, and the video coding apparatus may perform the video coding method shown in FIG. 15.

A person skilled in the art may easily figure out other implementations of the disclosure after considering the specification and practicing the implementations disclosed herein. The disclosure is intended to cover any variations, uses, or adaptive changes of the disclosure. These variations, uses, or adaptive changes follow general principles of the disclosure and include related knowledge or related technical means not disclosed in the disclosure in the technical field.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

The disclosure is not limited to precise structures described above and shown in the accompanying drawings, and various modifications and changes may be made without departing from the scope of the disclosure.

What is claimed is:

1. A method for video decoding, the method comprising:
receiving a video bitstream including coding information of a current block;
determining a filter coefficient of a filter for the current block based on an extrapolation filter-based intra prediction (EIP) mode, the filter coefficient being determined based on a correlation between pixel values of a reference region in a plurality of input positions of the filter and a pixel value of the reference region in an output position of the filter;
decoding a compensation value for the filter coefficient from the video bitstream;
generating an adjusted filter coefficient of the filter based on the compensation value and the filter coefficient; and
reconstructing the current block based on the adjusted filter coefficient of the filter.

2. The method according to claim 1, wherein the decoding the compensation value comprises:
decoding an absolute value of the compensation value and a sign corresponding to the compensation value from the video bitstream, the compensation value being indicated by a fixed bit length in the video bitstream; and
determining the compensation value based on the absolute value and the sign.

3. The method according to claim 1, wherein an absolute value of the compensation value is coded by context adaptive binary arithmetic coding in which a i-th bit value associated with an absolute value of a previous compensation value is a context for a i-th bit value associated with the absolute value of the compensation value, i being a positive integer.

4. The method according to claim 1, wherein the decoding the compensation value comprises:
decoding an index of the compensation value from the video bitstream; and
determining the compensation value in a preset compensation value list based on the index.

5. The method according to claim 1, wherein the generating comprises:
adding the filter coefficient with the compensation value to obtain the adjusted filter coefficient.

6. The method according to claim 5, wherein the reconstructing further comprises:
reconstructing a first region in the current block by using the filter coefficient of the filter; and
reconstructing a second region in the current block by using the adjusted filter coefficient of the current block.

7. The method according to claim 1, wherein the generating comprises:
reconstructing a first region in the current block by using the filter coefficient to obtain reconstructed pixels in the first region;
determining a derived filter coefficient for a second region based on the reconstructed pixels in the first region according to the EIP mode; and
adjusting the derived filter coefficient of the second region by using the compensation value to obtain the adjusted filter coefficient for the second region; and
the reconstructing the current block includes reconstructing the second region by using the adjusted filter coefficient.

8. The method according to claim 7, wherein the first region includes first top M rows and first left N columns in the current block, M being an integer equal to or larger than 0 and equal to or less than a number of rows of the current block, and N being an integer equal to or larger than 0 and equal to or less than a number of columns of the current block.

9. The method according to claim 7, wherein the first region includes first top H/T rows and first left W/S columns in the current block, H being equal to a number of rows of the current block, W being equal to a number of columns of the current block, T being equal to 2 raised to a power of a first positive integer and S being equal to 2 raised to a power of a second positive integer.

10. The method according to claim 7, wherein the second region includes a bottom-right corner region of the current block that is obtained by partitioning the current block in a direction from a top right corner of the current block to a bottom left corner of the current block.

11. The method according to claim 1, wherein the determining comprises:
determining the filter coefficient of the current block based on reconstructed pixels or predicted pixels in the reference region adjacent to the current block according to the EIP mode; or
determining a filter coefficient of a reference block as the filter coefficient of the current block.

12. A method for video encoding, the method comprising:
determining an actual filter coefficient of a filter for a current block based on reference samples of the current block;
determining a derived filter coefficient of the filter for the current block based on an extrapolation filter-based intra prediction (EIP) mode, the derived filter coefficient being determined based on a correlation between pixel values of a reference region in a plurality of input positions of the filter and a pixel value of the reference region in an output position of the filter;
determining a compensation value based on a difference between the actual filter coefficient and the derived filter coefficient;
performing intra prediction on the current block by using at least one of the actual filter coefficient or the derived filter coefficient of the filter based on the EIP mode; and
encoding the compensation value into a video bitstream.

13. The method according to claim 12, wherein the encoding further comprises:
encoding an absolute value of the compensation value and a sign corresponding to the compensation value into the video bitstream, the compensation value being indicated by a fixed bit length in the video bitstream.

14. The method according to claim 12, wherein the encoding further comprises:
entropy coding an absolute value of the compensation value by context adaptive binary arithmetic coding in which a i-th bit value associated with an absolute value of a previous compensation value is a context for a i-th bit value associated with the absolute value of the compensation value, i being a positive integer.

15. The method according to claim 12, wherein the encoding further comprises:
encoding an index of the compensation value into the video bitstream, the index indicating
the compensation value in a preset compensation value list.

16. The method according to claim 12, wherein the performing further comprises:
performing the intra prediction on a first region of the current block by using the derived filter coefficient of the filter according to the EIP mode; and
performing the intra prediction on a second region of the current block by using the actual filter coefficient of the filter according to the EIP mode.

17. The method according to claim 16, wherein the first region includes first top M rows and first left N columns in the current block, M being an integer equal to or larger than 0 and equal to or less than a number of rows of the current block, and N being an integer equal to or larger than 0 and equal to or less than a number of columns of the current block.

18. The method according to claim 16, wherein the first region includes first top H/T rows and first left W/S columns in the current block, H being equal to a number of rows of the current block, W being equal to a number of columns of the current block, T being equal to 2 raised to a power of a first positive integer and S being equal to 2 raised to a power of a second positive integer.

19. The method according to claim 12, wherein the determining the actual filter coefficient for the current block further comprises:
when the reference samples are of the reference region adjacent to the current block, determining the actual filter coefficient of the current block based on sample values of the reference region according to the EIP mode; and
when the reference samples are of a reference block of the current block, determining the actual filter coefficient of the current block as a filter coefficient of the reference block.

20. A non-transitory computer-readable storage medium storing instructions which, when executed by a processor, cause the processor to perform a method of encoding a video bitstream comprising:
determining an actual filter coefficient of a filter for a current block based on reference samples of the current block;
determining a derived filter coefficient of the filter for the current block based on an extrapolation filter-based intra prediction (EIP) mode, the derived filter coefficient being determined based on a correlation between pixel values of a reference region in a plurality of input positions of the filter and a pixel value of the reference region in an output position of the filter;
determining a compensation value based on a difference between the actual filter coefficient and the derived filter coefficient;
performing intra prediction on the current block by using at least one of the actual filter coefficient or the derived filter coefficient of the filter based on the EIP mode;
encoding the compensation value into the video bitstream; and
transmitting the encoded video bitstream.
